(19) United States
(12) Patent Application Publication
(10) Pub. No.: US 2026/0230439 A1
(43) Pub. Date: Aug. 6, 2026

(54) INTELLIGENT BUFFERING TO REDUCE POWER CONSUMPTION OF NEW RADIO (NR) - INTERNET OF THINGS (IOT) DEVICES

(71) Applicant: DISH Wireless L.L.C., Englewood, CO (US)

(72) Inventors: Rajesh Chilka, Littleton, CO (US); Kazi Bashir, Denton, TX (US); Mehdi Alasti, Arlington, VA (US); Ahmed Mostafa, Centennial, CO (US); Sourabh Gupta, Ashburn, VA (US)

(21) Appl. No.: 19/045,117

(22) Filed: Feb. 4, 2025

(51) Int. Cl. H04L 47/62; H04L 49/90

(52) U.S. Cl. CPC H04L 47/624; H04L 49/90

(57) ABSTRACT

Technologies for intelligent buffering to reduce power consumption of a user equipment (UE) in a cellular network are described. One method includes: receiving, by a network function, a data packet directed to a user equipment (UE), wherein the UE comprises an internet of things (IoT) device; storing the data packet in a buffer, wherein the buffer is specific to the network function; determining whether at least one parameter of a plurality of parameters associated with the data packet satisfies a threshold criterion, wherein the plurality of parameters associated with the data packet are specific to the network function; and responsive to determining that the at least one parameter satisfies the threshold criterion, sending, to an access and mobility management function (AMF), a notification to the UE, wherein the notification causes the AMF to send a paging message to the UE, and wherein the paging message indicates the UE to receive data packets stored in the buffer.

### BACKGROUND

Cellular networks are highly complex. One type of cellular network is a fifth generation (5G) new radio (NR) cellular network. 5G NR cellular networks have the promise to provide higher throughput, lower latency, and higher availability compared with previous global wireless standards. Some improvement can be implemented in the 5G NR cellular network to reduce the power consumed at the devices connected to the 5G NR cellular network.

### BRIEF DESCRIPTION OF THE DRAWINGS

The present disclosure is illustrated by way of example, and not by way of limitation, in the figures of the accompanying drawings.

FIG. 1 is a block diagram of a system implementing intelligent buffering in a cellular network to reduce power assumption of new radio (NR) internet of things (IoT) devices according to at least one embodiment.

FIG. 2 is a block diagram of a system including IoT power managers that implement intelligent buffering in a cellular network according to at least one embodiment.

FIGS. 3, 4A and 4B are flow diagrams of example methods of implementing intelligent buffering in a cellular network to reduce power assumption of new radio (NR) internet of things (IoT) devices according to at least one embodiment.

FIG. 5 is a block diagram of an example computer system in which embodiments of the present disclosure can operate.

### DETAILED DESCRIPTION

Technologies for implementing intelligent buffering to reduce the power consumption of a new radio (NR)-internet of things (IoT) device of a telecommunications network, such as a cellular network (e.g., 5G wireless network, 6G wireless network) are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

The user equipment (UE) connected to the cellular network consumes power when establishing the connection with the cellular network and receiving data from the cellular network. In some cases, paging is used by the cellular network to notify the UE regarding data reception, and whenever a network function receives a data packet directed to the UE, the access and mobility management function (AMF) in the cellular network will send a paging message the UE, which may cause the UE to consume power because, for each data packet, a separate paging message will be send to the UE.

Aspects and embodiments of the present disclosure address the above and other deficiencies by providing a system that implements intelligent buffering in a cellular network to reduce the power consumption of the UE, such as a new radio (NR)-internet of things (IoT) device. Specifically, a component of the cellular network (e.g., IoT power manager) may configure a buffer to store data packets for the relevant network function (e.g., user plane function (UPF), session management function (SMF), network exposure function (NEF), or application function (AF)) for the UE. For example, the component of the cellular network (e.g., IoT power manager) may receive, by a network function, a data packet directed to a UE and store the data packet in a buffer, where the UE comprises an internet of things (IoT) device, and the buffer is specific to the network function.

The component of the cellular network (e.g., IoT power manager) may configure a set of parameters associated with the data packets to be used for triggering a paging process, where the paging is used to notify the UE of the data packets reception. The set of parameters associated with the data packets may be specific to each network function, and may include the size of the data packets stored in the buffer (or the number of the data packets, if each data packet is in a uniform size), a timer started when storing the first data packet (i.e., the data packet that is first stored in an empty buffer) in the buffer, or a priority level of the data packet. The component of the cellular network (e.g., IoT power manager) may monitor the set of parameters and determine whether one or more parameters of the set of parameters associated with the data packet satisfies a respective threshold criterion for sending a notification to trigger the paging process.

In some implementations, the component of the cellular network (e.g., IoT power manager) may determine whether the size of the data packets stored in the buffer satisfies a first threshold value. In some implementations, the first threshold value is predetermined based on a service type, a UE type, a network slice, and/or a tenant associated with the network function. The component of the cellular network (e.g., IoT power manager) may determine that the size of the data packets stored in the buffer satisfies the first threshold value when the size of the data packets stored in the buffer is not smaller than the first threshold value.

In some implementations, the component of the cellular network (e.g., IoT power manager) may determine whether a timer started when storing a first data packet in the buffer satisfies a second threshold value. In some implementations, the second threshold value is predetermined based on a service type, a UE type, a network slice, and/or a tenant associated with the network function. The component of the cellular network (e.g., IoT power manager) may determine that the timer started when storing a first data packet in the buffer satisfies the second threshold value when the timer started when storing a first data packet in the buffer is not smaller than the second threshold value. In some implementations, the component of the cellular network (e.g., IoT power manager) may set the timer to be started when storing a first data packet in the buffer, and responsive to sending the data packets stored in the buffer to the UE, reset the timer and restart the timer when storing the first data packet in the buffer again.

In some implementations, the component of the cellular network (e.g., IoT power manager) may determine whether a priority level of the data packet that is just stored satisfies a third threshold value that indicates a high priority level. The component of the cellular network (e.g., IoT power manager) may determine that the priority level of the data packet satisfies the third threshold value when the priority level of the data packet is not smaller than the third threshold value.

Responsive to determining that one or more parameters of the set of parameters associated with the data packet satisfies a respective threshold criterion, the component of the cellular network (e.g., IoT power manager) may send, to an access and mobility management function (AMF), a notification to the UE, where the notification causes the AMF to send a paging message to the UE, and the paging message indicates the UE to receive data packets stored in the buffer. As such, by accumulating multiple data packets to send one paging message, rather than sending one paging message for each separate data packet, the UE can reduce the time it is used for monitoring paging, and thus reduce the power consumption.

Aspects and embodiments of the present disclosure can use the intelligent buffering to accumulate the data packets before triggering the paging process. Aspects and embodiments of the present disclosure can be used in the Non-IP data delivery (NIDD) case, where the data can be delivered without using any IP address. The (narrowband IoT) NB-IoT devices may include smart sensors and the reduced capacity (RedCap) devices for mid-range IoT applications such as extended reality (XR) glasses and health monitors.

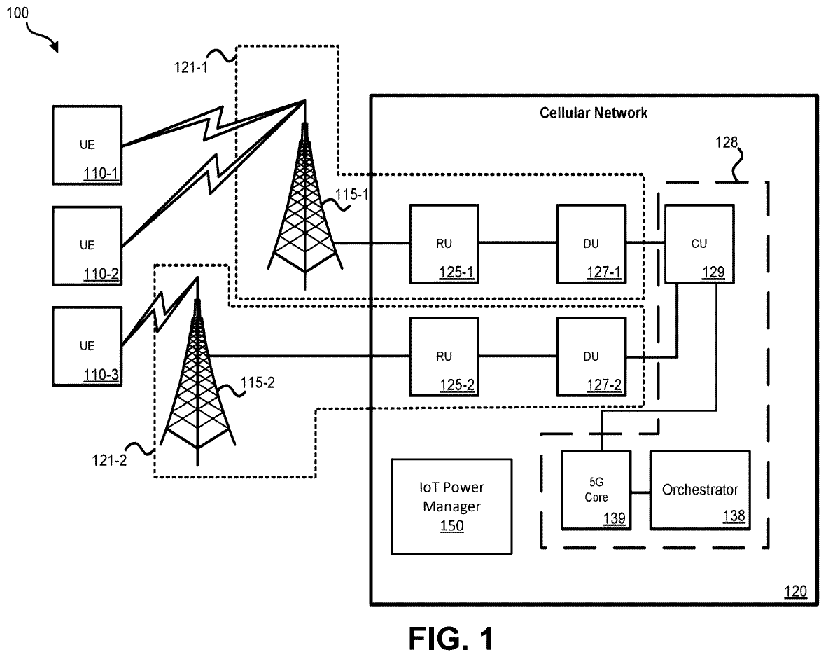

FIG. 1 illustrates an embodiment of a cellular network system 100 (“system 100”). FIG. 1 represents an embodiment of a cellular network which can accommodate the cloud-based architecture. System 100 can include a 5G New Radio (NR) cellular network; other types of cellular networks, such as 6G, 7G, etc. may also be possible. System 100 can include: UEs 110 (UE 110-1, UE 110-2, UE 110-3); base station structure 115; cellular network 120; radio units 125 (“RUs 125”); distributed units 127 (“DUs 127”); centralized unit 129 (“CU 129”); 5G core 139, and orchestrator 138. FIG. 1 represents a component-level view. In an open radio access network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

UE 110 can represent various types of end-user devices, such as cellular phones, smartphones, cellular modems, cellular-enabled computerized devices, sensor devices, gaming devices, access points (APs), any computerized device capable of communicating via a cellular network, etc. Generally, UE can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Depending on the location of individual UEs, UE 110 may use RF to communicate with various base stations of cellular network 120. As illustrated, two base stations are illustrated: base station 121-1 can include: structure 115-1, RU 125-1, and DU 127-1. Structure 115-1 may be any structure to which one or more antennas (not illustrated) of the base station are mounted. Structure 115-1 may be a dedicated cellular tower, a building, a water tower, or any other human-made or natural structure to which one or more antennas can reasonably be mounted to provide cellular coverage to a geographic area. Similarly, base station 121-2 can include: structure 115-2, RU 125-2, and DU 127-2.

Real-world implementations of system 100 can include many (e.g., thousands) of base stations and many CUs and 5G core 139. BS 115 can include one or more antennas that allow RUs 125 to communicate wirelessly with UEs 110. RUs 125 can represent an edge of cellular network 120 where data is transitioned to wireless communication. The radio access technology (RAT) used by RU 125, DU 127, and/or CU 129, may be 5G New Radio (NR), or some other RAT. The remainder of cellular network 120 may be based on an exclusive 5G architecture, a hybrid 4G/5G architecture, a 4G architecture, or some other cellular network architecture. Base station equipment 121 may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1, may communicate with CU 129. Collectively, an RU, DU, and CU create a gNodeB, which serves as the radio access network (RAN) of cellular network 120. CU 129 can communicate with 5G core 139. The specific architecture of cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1 illustrates various components of cellular network 120, other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized O-RAN implementation, CU 129, 5G core 139, and/or orchestrator 138 can be implemented virtually as software being executed by general-purpose computing equipment, such as in a data center of a cloud-computing platform, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129, 5G core 139, and orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

Kubernetes, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new core function, orchestrator 138 can perform a pipeline of calling the core function code from a software repository incorporated as part of, or separate from, cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QoS) and quality of experience (QoE) for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

5G core 139, which can be physically distributed across data centers or located at a national data centers (NDCs) and regional data centers (RDCs), can perform various core functions of the cellular network. 5G core 139 can include: network resource management components; policy management components; subscriber management components; and packet control components. Individual components may communicate on a bus, thus allowing various components of 5G core 139 to communicate with each other directly. 5G core 139 is simplified to show some key components. Implementations can involve additional other components.

Network resource management components can include network repository function (NRF) and network slice selection function (NSSF). NRF can allow 5G network functions (NFs) to register and discover each other via a standards-based application programming interface (API). NSSF can be used by access and mobility management function (AMF) to assist with the selection of a network slice that will serve a particular UE.

Policy management components can include charging function (CHF) and policy control function (PCF). CHF allows charging services to be offered to authorized network functions. Converged online and offline charging can be supported. PCF allows for policy control functions and the related 5G signaling interfaces to be supported.

Subscriber management components can include unified data management (UDM) and authentication server function (AUSF). UDM can allow for generation of authentication vectors, user identification handling, NF registration management, and retrieval of UE individual subscription data for slice selection. AUSF performs authentication with UE.

Packet control components can include access and mobility management function (AMF) and session management function (SMF). AMF can receive connection-and session-related information from UE and is responsible for handling connection and mobility management tasks. SMF is responsible for interacting with the decoupled data plane, creating, updating, and removing protocol data unit (PDU) sessions, and managing session context with the user plane function (UPF).

User plane function (UPF) can be responsible for packet routing and forwarding, packet inspection, QoS handling, and external PDU sessions for interconnecting with a data network (DN) (e.g., the Internet) or various access networks. Access networks can include the RAN of cellular network 120.

5G core 139 may reside on a cloud computing platform. While from a client's or user's point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

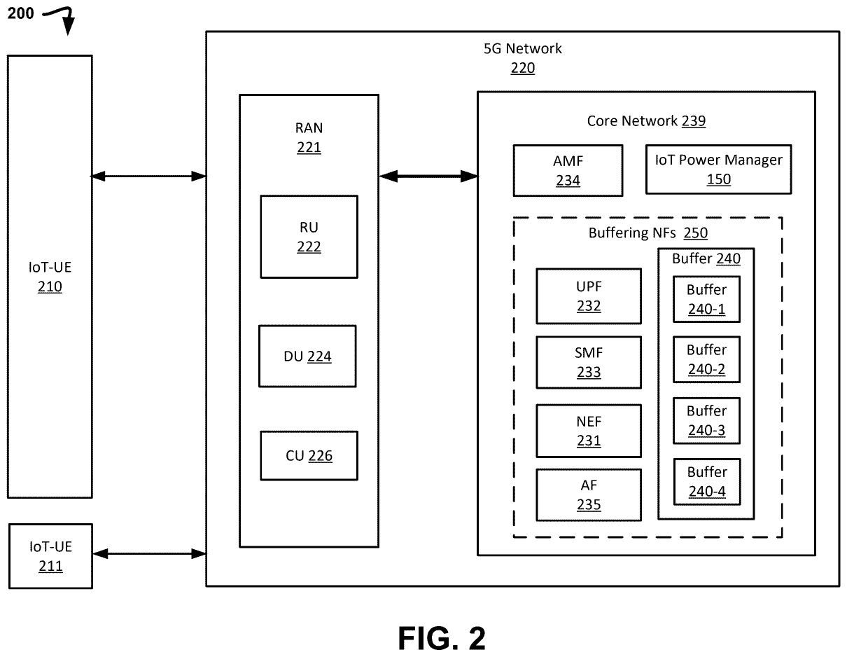

In some embodiments, the cellular network 120 includes an IoT power manager 150 that implements intelligent buffering in a cellular network to reduce power assumption of UE. Further details regarding the operations of the IoT power manager 150 are described below with reference to FIGS. 2-5.

FIG. 2 is a block diagram of example IoT power manager that implements intelligent buffering in a cellular network according to at least one embodiment. Referring to FIG. 2, a 5G network 220 includes one or more radio access networks (RANs) 221 and a core network 239 according to at least one embodiment. In at least one embodiment, the IoT power manager 150 can be implemented in the core network 239. In at least one embodiment, the IoT power manager 150 can be implemented in the 5G network 220. In at least one embodiment, the IoT power manager 150 can be implemented in each RAN 221.

The 5G network 220 connects user equipment (UE) to the data network (not shown), and the data network can include the Internet, a local area network (LAN), a wide area network (WAN), a private data network, a wireless network, a wired network, or a combination of networks. The UE can include an electronic device with wireless connectivity or cellular communication capability, such as a mobile phone or handheld computing device. In at least one example, the UE can include a 5G smartphone or a 5G cellular device that connects to the RAN 221 via a wireless connection. The UE can include one of a number of UEs not depicted that are in communication with the RAN 221. Referring to FIG. 2, the UE may be Internet-of-Things (IoT) UE 210, 211, and include one or more Internet-of-Things (IoT) devices, and/or any other electronic computing device that includes a wireless communications interface to access the RAN 221.

The RAN 221 includes a radio unit (RU) 222 for wirelessly communicating with IoT-UE 210. The radio unit (RU) 222 can include a Radio Unit and may include one or more radio transceivers for wirelessly communicating with IoT-UE 210. The remote radio unit (RU) 222 may include circuitry for converting signals sent to and from an antenna of a Base Station into digital signals for transmission over packet networks. The RAN 221 may correspond with a 5G radio Base Station that connects user equipment to the core network 239. The 5G radio Base Station may be referred to as a generation Node B, a “gNodeB,” or a “gNB.” A Base Station may refer to a network element that is responsible for the transmission and reception of radio signals in one or more cells to or from user equipment, such as IoT-UE 210. The RAN 221 can include a new-generation radio access network (NG-RAN) that uses the 5G NR interface. In some embodiments, the distributed unit (DU) 224 and the centralized unit (CU) 226 of the RAN 221 may be co-located with the radio unit (RU) 222. In other embodiments, the distributed unit (DU) 224 and the radio unit (RU) 222 may be co-located at a cell site and the centralized unit (CU) 226 may be located within a local data center (LDC). The distributed unit (DU) 224 can include a logical node configured to provide functions for the radio link control (RLC) layer, the medium access control (MAC) layer, and the higher physical layer (Hi-PHY) layers. The centralized unit (CU) 226 can include a centralized unit for the user plane (CU-UP) and a centralized unit for the control plane (CU-CP). In one example, the centralized unit (CU) 226 can include a logical node configured to provide functions for the radio resource control (RRC) layer, the packet data convergence control (PDCP) layer, and the service data adaptation protocol (SDAP) layer. The centralized unit for the control plane can include a logical node configured to provide functions of the control plane part of the RRC and PDCP. The centralized unit for the user plane can include a logical node configured to provide functions of the user plane part of the SDAP and PDCP. In some embodiments, the RAN 221 may include virtualized CU units and virtualized DU units. The virtualized DU units can include virtualized versions of distributed units (DUs). The virtualized CU units can include virtualized versions of centralized units (CUs). Virtualizing the control plane and user plane functions allows the centralized units (CUs) to be consolidated in one or more data centers on RAN-based open interfaces.

In some embodiments, the RAN 221 may include a set of one or more remote radio units (RUs) that includes radio transceivers (or combinations of radio transmitters and receivers) for wirelessly communicating with UEs. The set of RUs may correspond with a network of cells (or coverage areas) that provide continuous or nearly continuous overlapping service to UEs, such as IoT-UE 210, over a geographic area. Some cells may correspond with stationary coverage areas and other cells may correspond with coverage areas that change over time (e.g., due to movement of a mobile RU).

In some cases, the IoT-UE 210 may be capable of transmitting signals to and receiving signals from one or more RUs within the network of cells over time. One or more cells may correspond with a cell site. The cells within the network of cells may be configured to facilitate communication between IoT-UE 210 and other UEs and/or between IoT-UE 210 and a data network. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 feet). Small cells may communicate through macrocells. Although the range of small cells may be limited, small cells may enable mmWave frequencies with high-speed connectivity to UEs within a short distance of the small cells. Macrocells may transit and receive radio signals using multiple-input multiple-output (MIMO) antennas that may be connected to a cell tower, an antenna mast, or a raised structure.

The core network 239 may utilize a cloud-native service-based architecture (SBA) in which different core network functions (e.g., authentication, security, session management, and core access and mobility functions) are virtualized and implemented as loosely coupled independent services that communicate with each other, for example, using hypertext transfer protocol (HTTP) protocols and APIs. In some cases, control plane (CP) functions may interact with each other using the service-based architecture. In at least one embodiment, a microservices-based architecture in which software is composed of small independent services that communicate over well-defined APIs may be used for implementing some of the core network functions. For example, control plane (CP) network functions for performing session management may be implemented as containerized applications or microservices. Although a microservice-based architecture does not necessarily require a container-based implementation, a container-based implementation may offer improved scalability and availability over other approaches. Network functions that have been implemented using microservices may store their state information using the unstructured data storage function (UDSF) that supports data storage for stateless network functions across the service-based architecture (SBA).

The core network 239 may include a set of network elements that are configured to offer various data and telecommunications services to subscribers or end users of user equipment, such as IoT-UE 210. Examples of network elements include network computers, network processors, networking hardware, networking equipment, routers, switches, hubs, bridges, radio network controllers, gateways, servers, virtualized network functions, and network functions virtualization infrastructure. A network element can include a real or virtualized component that provides wired or wireless communication network services.

The primary core network functions can include the access and mobility management function (AMF) 234, the session management function (SMF) 233, and the user plane function (UPF) 232. The AMF 234 may act as a single-entry point for a UE connection and perform mobility management, registration management, and connection management between a data network and UE. The AMF 234 may interface with the SMF 233 to track user sessions. The AMF 234 may interface with a network slice selection function (NSSF) to select network slice instances for user equipment. When user equipment is leaving a first coverage area and entering a second coverage area, the AMF 234 may be responsible for coordinating the handoff between the coverage areas whether the coverage areas are associated with the same radio access network or different radio access networks.

The SMF 233 may perform session management, user plane selection, and IP address allocation. SMF 233 is responsible for interacting with the decoupled data plane, creating updating and removing protocol data unit (PDU) sessions, and managing session context with the user plane function (UPF) 232 (e.g., manage UE context and network handovers between base stations). The SMF 233 may configure or control the UPF 232 via the N4 interface. For example, the SMF 233 may control packet forwarding rules used by the UPF 232 and adjust QoS parameters for QoS enforcement of data flows (e.g., limiting available data rates). In some cases, multiple SMF/UPF pairs may be used to simultaneously manage user plane traffic for a particular user device, such as IoT-UE 210. For example, a set of SMFs may be associated with IoT-UE 210, where each SMF of the set of SMFs corresponds with a network slice. The SMF 233 may control the UPF 232 on a per end user data session basis, in which the SMF 233 may create, update, and remove session information in the UPF 232.

The UPF 232 may perform packet processing including routing and forwarding, quality of service (QoS) handling, and packet data unit (PDU) session management. The UPF 232 may serve as an ingress and egress point for user plane traffic and provide anchored mobility support for user equipment. The UPF 232 may be implemented as a software process or application running within a virtualized infrastructure or a cloud-based compute and storage infrastructure. The UPF 232 may transfer downlink data received from the data network to user equipment, via the RAN 221 and/or transfer uplink data received from user equipment to the data network via the RAN 221. An uplink can include a radio link though which user equipment transmits data and/or control signals to the RAN 221. A downlink can include a radio link through which the RAN 221 transmits data and/or control signals to the user equipment.

Uplink packets arriving from the RAN 221 may use a general packet radio service (GPRS) tunneling protocol (or GTP) to reach the UPF 232. The GPRS tunneling protocol for the user plane may support multiplexing of traffic from different PDU sessions by tunneling user data over the interface between the RAN 221 and the UPF 232. The UPF 232 may remove the packet headers belonging to the GTP tunnel before forwarding the user plane packets towards the data network. As the UPF 232 may provide connectivity towards other data networks in addition to the data network, the UPF 232 must ensure that the user plane packets are forwarded towards the correct data network. Each GTP tunnel may belong to a specific PDU session. Each PDU session may be set up towards a specific data network name (DNN) that uniquely identifies the data network to which the user plane packets should be forwarded. The UPF 232 may keep a record of the mapping between the GTP tunnel, the PDU session, and the DNN for the data network to which the user plane packets are directed.

Downlink packets arriving from the data network are mapped onto a specific QoS flow belonging to a specific PDU session before forwarded towards the appropriate RAN 221. A QoS flow may correspond with a stream of data packets that have equal quality of service (QoS). The PDU session may utilize one or more quality of service (QoS) flows to exchange traffic (e.g., data and voice traffic) between the IoT-UE 210 and the data network. The one or more QoS flows can include the finest granularity of QoS differentiation within the PDU session. The PDU session may belong to a network slice instance through the 5G network 220. To establish user plane connectivity from the IoT-UE 210 to the data network, an AMF that supports the network slice instance may be selected and a PDU session via the network slice instance may be established. In some cases, the PDU session may be of type IPv4 or IPv6 for transporting IP packets. The RAN 221 may be configured to establish and release parts of the PDU session that cross the radio interface.

Another core network function may be an application function (AF) 235 for providing application services. Other core network functions may include a network repository function (NRF) for maintaining a list of available network functions and providing network function service registration and discovery, a policy control function (PCF) for enforcing policy rules for control plane functions, an authentication server function (AUSF) for authenticating user equipment and handling authentication related functionality, a network slice selection function (NSSF) for selecting network slice instances. Application-level session information may be exchanged between the AF and PCF (e.g., bandwidth requirements for QoS). In some cases, when user equipment requests access to resources, such as establishing a PDU session or a QoS flow, the PCF may dynamically decide if the user equipment should grant the requested access based on a location of the user equipment.

The core network 239 may include network exposure function (NEF) 231. The NEF 231 may support exposure of network functions capabilities in the core network 239 to external network functions such as third party application functions. External exposure can be categorized as monitoring capability, provisioning capability, policy/charging capability, and analytics reporting capability. The monitoring capability may involve monitoring of specific event for UE and making such monitoring events information available for external exposure via the NEF. The provisioning capability may involve allowing external party to provision of information which can be used for the UE. The policy/charging capability may involve handling QoS and charging policy for the UE based on the request from external party. The analytics reporting capability may involve allowing an external party to fetch or subscribe/unsubscribe to analytics information generated by core network 239 (e.g., roaming status of a specific UE is reported by UDM to NEF and the NEF will transfer it to the 3rd party network function). The NEF 231 may serve as a security layer to untrusted third party applications.

The 5G network 220 may provide one or more network slices, where each network slice may include a set of network functions that are selected to provide specific telecommunications services. For example, each network slice can include a configuration of network functions, network applications, and underlying cloud-based compute and storage infrastructure. In some cases, a network slice may correspond with a logical instantiation of a 5G network, such as an instantiation of the 5G network 220. In some cases, the 5G network 220 may support customized policy configuration and enforcement between network slices per service level agreements (SLAs) within the radio access network (RAN) 221. User equipment, such as IoT-UE 210, may connect to multiple network slices at the same time (e.g., eight different network slices). In some cases, the 5G network 220 may dynamically generate network slices to provide telecommunications services for various use cases, such the enhanced Mobile Broadband (eMBB), Ultra-Reliable and Low-Latency Communication (URLLC), and massive Machine Type Communication (mMTC) use cases.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents.

Virtualization allows virtual hardware to be created and decoupled from the underlying physical hardware. One example of a virtualized component is a virtual router (or a vRouter). Another example of a virtualized component is a virtual machine. A virtual machine can include a software implementation of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64 GB virtual disk) for the virtual machine. Another example of a virtualized component is a software container or an application container that encapsulates an application's environment. In some embodiments, applications and services may be run using virtual machines instead of containers in order to improve security. A common virtual machine may also be used to run applications and/or containers for a number of closely related network services.

The 5G network 220 may implement various network functions, such as the core network functions and radio access network functions, using a cloud-based compute and storage infrastructure. A network function may be implemented as a software instance running on hardware or as a virtualized network function. Virtual network functions (VNFs) can include implementations of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

Paging is a procedure used by the network to inform and notify IoT-UE 210 about various events. Extended discontinuous reception (eDRX) is a mechanism that enables setting and modifying how long an edge device (e.g., IoT-UE 210) stays in low-power sleep (“idle”) mode before it wakes up to listen for any network indications for pending data reception. With eDRX, the IoT-UE 210 can listen for pending data indications without having to establish a full network connection, and therefore uses less power than if it made a full network connection. The time needed for this listening process is also much shorter than the time it takes to make a full network connection. The IoT-UE 210 that leverages eDRX is only required to be active for a period of time for monitoring paging (“a paging cycle,”) over a period of time in sleep (“eDRX cycle”). The IoT-UE 210 can set up and modify the length of the eDRX cycle as a fixed value.

In some cases, while IoT-UE 210 is in the idle mode, IoT-UE 210 periodically wake up and monitor whether the network is sending any paging message, for example, by checking for the presence of a paging message in a physical downlink control channel (PDCCH). If determining the presence of a paging message, IoT-UE 210 demodulates the paging channel to check whether the paging message is directed to IoT-UE 210

Early paging indication (EPI) is a mechanism where IoT-UE 210 is notified in advance of whether a paging occasion is about to occur. Thus, IoT-UE 210 can skip the time-frequency synchronization prior to a paging occasion when no paging occasion is about to occur (i.e., IoT-UE 210 does not need to monitor the paging occasion). Specifically, to enable the communication, both UE (e.g., IoT-UE 210) and base station (e.g., RAN 221) in the communication needs to reach agreement on the common configuration, such as using radio resource control (RRC) messages including system information type1 (SIB1) to reach agreement on configuration parameters, and the SIB1 may be used to inform UE about the EPI configuration. The EPI can be signaled via a downlink control information (DCI) message carried in the physical downlink control channel (PDCCH) signal that carries downlink control information or via a reference signal (e.g., the secondary synchronization signal (SSS)) broadcasted by the base station.

In some cases, upon detecting the presence of an EPI in the received message, IoT-UE 210 can determine whether to prepare for paging occasion reception by monitoring the synchronization signal block (SSB) burst. Otherwise, IoT-UE 210 may sleep until it needs to perform inter-frequency measurements. The EPI may be signaled using: RRC connected wake-up signal DCI, paging DCI, or a sequence, e.g., secondary synchronization signal (SSS) or tracking reference signal (TRS). The power saving results from the reduction of SSB burst monitoring and PDCCH and PDSCH reception and as a consequence the increased sleeping time.

Buffering mechanism refers to the mechanism where when a network function receives a data packet for IoT-UE 210, the network function may store the data packet in a buffer and notify AMF such that the AMF can send a paging message to IoT-UE 210 (e.g., in the next paging cycle), and then the network function can send the stored data packet to IoT-UE 210. The IoT power manager 150 may perform an improved buffering mechanism by monitoring one or more parameters associated with the buffered data packet(s). The IoT power manager 150 may determine whether one or more parameters associated with the buffered data packet(s) satisfy a notification criterion, and responsive to determining that at least one parameter satisfies the notification criterion, notify AMF such that the AMF can send a paging message to IoT-UE 210, and then the network function can send the stored data packet to IoT-UE 210.

As shown in FIG. 2, the network function, such as UPF 232, SMF 233, NEF 231, or AF 235, may receive a data packet and store the received data packet in the buffer 240. There network functions may be referred to as buffering network functions, and included in the buffering NFs 250. In some implementations, UPF 232 may store the data packet(s) in the buffer 240-1, SMF 233 may store the data packet(s) in the buffer 240-2, NEF 231 may store the data packet(s) in the buffer 240-3, and AF 235 may store the data packet(s) in the buffer 240-4.

The parameters associated with the buffered data packet(s) may be specific to each network function, and may include the size (or the number, if each data packet is in a uniform size) of the data packets stored in the buffer, a timer started when storing the first data packet (the data packet that is stored for the first time in an empty buffer) in the buffer, or a priority level of the received data packet.

In some implementations, the IoT power manager 150 may monitor the size of the data packets stored in the buffer 240 for each of UPF 232, SMF 233, NEF 231, AF 235. In some implementations, the IoT power manager 150 may monitor the number of the data packets stored in the buffer 240 for each of UPF 232, SMF 233, NEF 231, AF 235, if each data packet is in a uniform size. In some implementations, responsive to storing, by a network function (e.g., UPF 232, SMF 233, NEF 231, or, AF 235), a new data packet in the corresponding buffer (e.g., buffer 240-1, 240-2, 240-3, or 240-4), the IoT power manager 150 may determine whether the size of the data packets stored in the corresponding buffer is larger than or equal to a threshold value (e.g., a first threshold value), and responsive to determining that the size of the data packets is larger than or equal to the threshold value, the IoT power manager 150 may determine that the notification criterion is satisfied.

In some implementations, the IoT power manager 150 may monitor a timer (“notification timer”) started when storing the first data packet in the buffer 240 for each of UPF 232, SMF 233, NEF 231, AF 235. In some implementations, the IoT power manager 150 may monitor a timer started when storing the first data packet in the buffer 240-1, monitor a timer started when storing the first data packet in the buffer 240-2, monitor a timer started when storing the first data packet in the buffer 240-3, and monitor a timer started when storing the first data packet in the buffer 240-4. In some implementations, responsive to storing, by a network function (e.g., UPF 232, SMF 233, NEF 231, or AF 235), a new data packet in the corresponding buffer (e.g., buffer 240-1, 240-2, 240-3, or 240-4), the IoT power manager 150 may determine whether the timer meets or exceeds (e.g., is larger than or equal to) a threshold value (e.g., a second threshold value), and responsive to determining that the timer meets or exceeds (e.g., is larger than or equal to) the threshold value, the IoT power manager 150 may determine that the notification criterion is satisfied. In some implementations, the IoT power manager 150 may configure the notification timer. In some implementations, the IoT power manager 150 may reset the value of the notification timer upon that the corresponding network function sends the buffered data packets and flush the buffer (i.e., delete the data such that the buffer is considered as “empty”), and restart the notification timer upon storing a data packet as the first one in the empty buffer.

In some implementations, the IoT power manager 150 may monitor a priority level of the data packet stored in the buffer 240 for each of UPF 232, SMF 233, NEF 231, AF 235. In some implementations, the priority level of the data packet may be specified in the metadata of the data packet and may be indicated by a bit value. In some implementations, the priority level of the data packet may be categorized as high, medium, or low, each represented by a specific bit value or range. In some implementations, the priority level of the data packet may be determined as high when the bit value is not smaller than a threshold value. In some implementations, responsive to storing, by a network function (e.g., UPF 232, SMF 233, NEF 231, or AF 235), a new data packet in the corresponding buffer (e.g., buffer 240-1, 240-2, 240-3, or 240-4), the IoT power manager 150 may determine whether the new data packet has a high priority level (e.g., a third threshold value), and responsive to determining that the new data packet has a high priority level, the IoT power manager 150 may determine that the notification criterion is satisfied.

Responsive to determining that a notification criterion is not satisfied, the IoT power manager 150 may continue allowing the network function to receive new data packet and keep monitoring the parameters associated with the data packet described above.

Responsive to determining that a notification criterion is satisfied, the IoT power manager 150 may notify the AMF 234 to send a paging message to IoT-UE 210 (e.g., in the next paging cycle), and then the data packet(s) stored in the corresponding buffer will be sent to IoT-UE 210. Using UPF 232 as an illustrative example, a paging message is used to establish a signaling connection, and thus paging is triggered by downlink packets arriving to the UPF 232. When the UPF 232 receives a downlink packet destined for the idle IoT-UE 210, the UPF 232 may not have a RAN user plane tunnel address to which it can send the packet, and the UPF 232 instead buffers the packet (e.g., store the packet in the buffer 240-1) and informs the SMF 233 that a downlink packet has arrived. The SMF 233 asks the AMF 234 to setup user plane resources for the PDU session, and the AMF 234 knows which RAN the UE is located and sends a paging message to the RAN. The RAN calculates at which occasion the UE is to be paged, and then the RAN pages the UE. Upon receiving the paging message, the UE responds to the AMF 234 and the user plane resources are activated so that the downlink packet may be forwarded from the buffer to the UE.

In some implementations, after the AMF 234 sends a paging message to IoT-UE 210 in the next paging cycle, IoT-UE 210 may send a response to the paging message. In some implementations, after the AMF 234 sends a paging message to IoT-UE 210 in the next paging cycle, IoT-UE 210 may be in an idle mode and may not respond to the paging message.

In some implementations, the AMF 234 sends a paging message to IoT-UE 210 via the RAN 221, and the AMF 234 may determine whether it receives a response to the paging message to determine whether the paging is successful. In some implementations, responsive to determining that AMF 234 receives a response to the paging message, the IoT power manager 150 may determine that the paging is successful, and cause the data packet(s) stored in the corresponding buffer to be sent to IoT-UE 210. In some implementations, responsive to determining that AMF 234 does not receive a response to the paging message, the IoT power manager 150 may determine that the paging is not successful, and setup another timer to indicate the length of the time that IoT-UE 210 has not responded (“non-responding timer”). The non-responding timer and the size of the buffered data packet(s) may be used to determine whether to take an action towards the buffered data packet(s).

In some implementations, the IoT power manager 150 may determine whether an action criterion is satisfied by determining whether the non-responding timer meets or exceeds a threshold value (e.g., a fourth threshold value) or whether the size of the buffered data packet(s) meets or exceeds a threshold value (e.g., a fifth threshold value). In some implementations, the IoT power manager 150 may determine that the action criterion is satisfied by determining that the non-responding timer meets or exceeds the threshold value, and the IoT power manager 150 may take the action towards the buffered data packet(s). In some implementations, the IoT power manager 150 may determine that the action criterion is satisfied by determining that the size of the buffered data packet(s) meets or exceeds the threshold value, and the IoT power manager 150 may take the action towards the buffered data packet(s). In some implementations, the action towards the buffered data packet(s) may include flushing the buffer, which means deleting the data in the buffer. In some implementations, the action towards the buffered data packet(s) may include flushing the buffer to delete the data packets and sending a notification to the entity that generates the data packet(s) regarding the delivery failure of these data packets.

In some implementations, a system (e.g., system 100 in FIG. 1, or system 200 in FIG. 2) may include a computing system to facilitate a cellular network (e.g., the cellular network 120 in FIG. 1, or 5G network in FIG. 2), the computing system may include one or more processing devices and memory communicatively coupled with and readable by the one or more processing devices and having stored therein processor-readable instructions which, when executed by the one or more processing devices, cause the one or more processing devices to perform operations described herein.

The computing system may be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The processing device may represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like. Processing device may be configured to execute processor-readable instructions for performing the operations and steps discussed herein.

The memory may represent any combination of the different types of non-volatile memory devices (e.g., not-and (NAND) type flash memory and write-in-place memory, such as a three-dimensional cross-point (“3D cross-point”) memory device) and/or volatile memory devices (e.g., random access memory (RAM), such as dynamic random access memory (DRAM) and synchronous dynamic random access memory (SDRAM)). Examples of memory include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory further include a dual in-line memory module (DIMM), a small outline DIMM (SO-DIMM), and various types of non-volatile dual in-line memory modules (NVDIMMs).

In some implementations, a system (e.g., system 100 in FIG. 1, or system 200 in FIG. 2) may include one or more non-transitory, computer-readable storage media having computer-readable instructions thereon which, when executed by one or more processing devices, cause the one or more processing devices to perform operations described herein. The term “computer-readable storage medium” should be taken to include a single medium or multiple media that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. Processor-readable instructions or computer-readable instructions may include instructions to implement functionality corresponding to a periodicity parameter manager (e.g., the IOT power manager 150 of FIGS. 1 and 2).

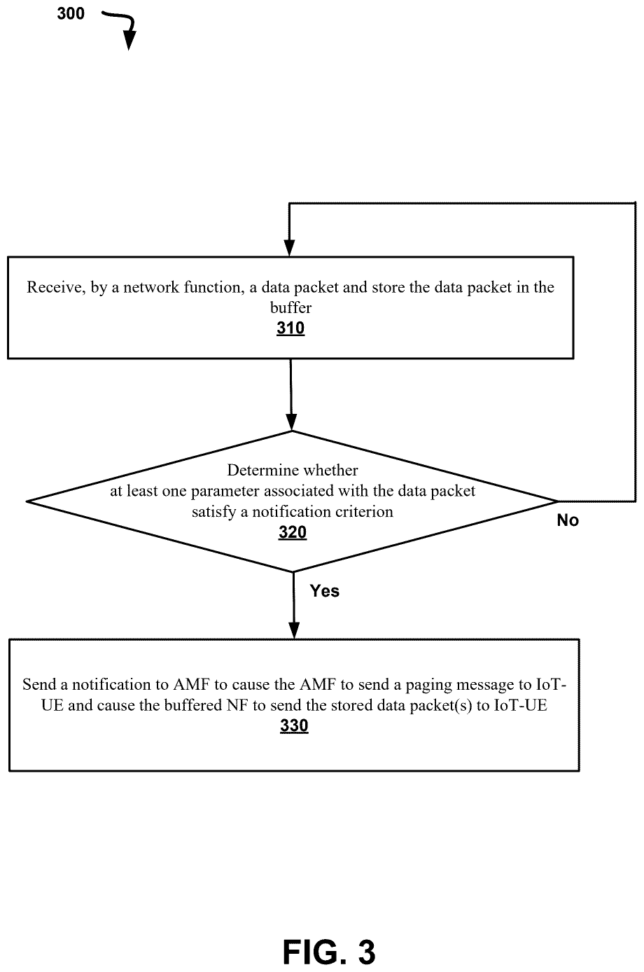

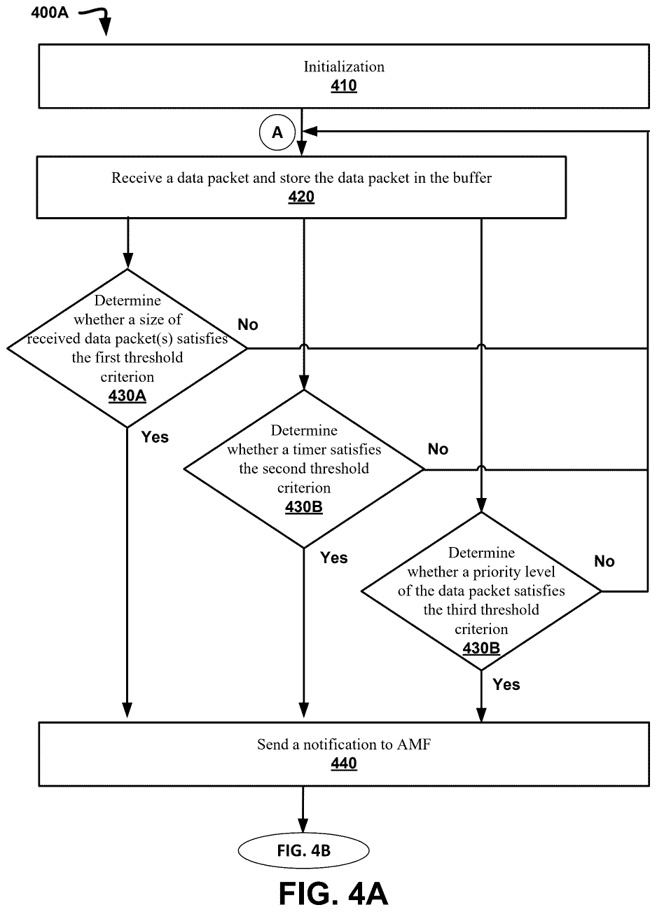

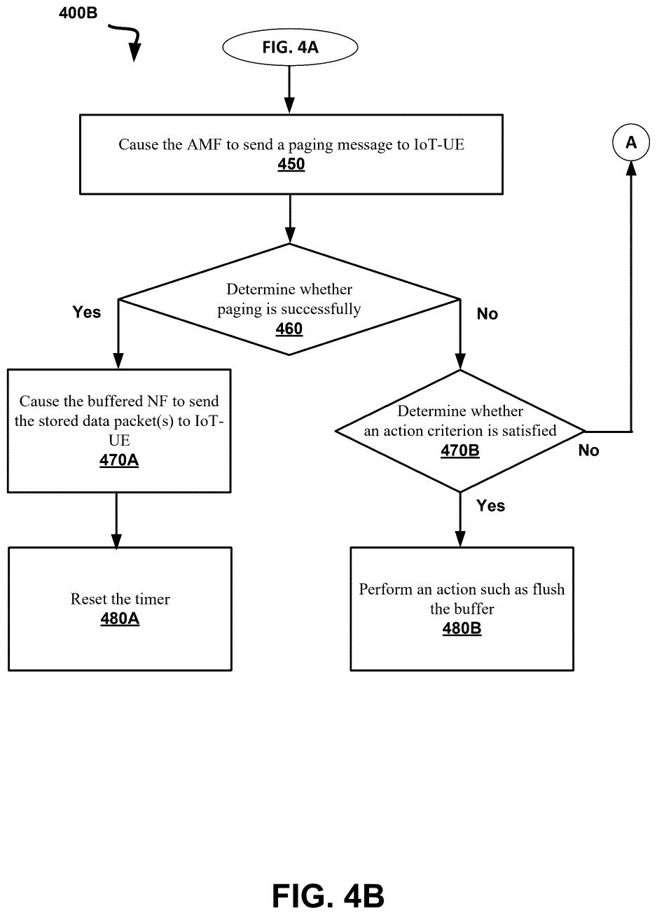

FIGS. 3 and 4A and 4B are flow diagrams of methods 300, 400A, and 400B of implementing intelligent buffering in a cellular network according to at least one embodiment. The methods 300, 400A, and 400B may be performed by processing logic that may comprise hardware (e.g., circuitry, dedicated logic, programmable logic, microcode, etc.), software (e.g., instructions run on a processing device to perform hardware simulation), or a combination thereof. In one embodiment, the methods 300, 400A, and 400B are performed by the system 100 of FIG. 1 or the system 200 of FIG. 2. In one embodiment, the methods 300, 400A, and 400B are performed by the IoT power manager 150 of FIG. 1 or 2.

Referring to FIG. 3, at operation 310, the processing device may receive, by a network function, a data packet directed to a UE (e.g., IoT-UE 210), wherein the UE comprises an internet of things (IoT) device. The processing device may store the data packet in a buffer (e.g., buffer 240), wherein the buffer is specific to the network function. In some implementations, the network function comprises at least one of: user plane function (UPF), session management function (SMF), network exposure function (NEF), application function (AF).

At operation 320, the processing device may determine whether at least one parameter of the plurality of parameters associated with the data packet satisfies a threshold criterion (“notification criterion”), wherein the plurality of parameters associated with the data packet are specific to the network function. In some implementations, the plurality of parameters comprise at least one of: a size of data packets stored in the buffer, a timer started when storing a first data packet in the buffer, or a priority level of the data packet.

In some implementations, the processing device determines that a size of data packets stored in the buffer meets or exceeds a threshold value to determine that the at least one parameter satisfies the notification criterion and proceeds to operation 330. In some implementations, the at least one parameter comprises a size of the data packets stored in the buffer, the threshold criterion comprises a first threshold value, and to determine the at least one parameter satisfies the threshold criterion, the processing device determines that the size of the data packets stored in the buffer is not smaller than the first threshold value, wherein the first threshold value is predetermined based on at least one of: a service type, a UE type, a network slice, or a tenant associated with the network function.

In some implementations, the processing device determines that a timer started when storing a first data packet in the buffer meets or exceeds a threshold value to determine that the at least one parameter satisfies the notification criterion and to proceed to operation 330. In some implementations, the at least one parameter comprises a timer started when storing a first data packet in the buffer, the threshold criterion comprises a second threshold value, and to determine the at least one parameter satisfies the threshold criterion, the processing device determines that the timer started when storing the first data packet the buffer is not smaller than the second threshold value, wherein the second threshold value is predetermined based on at least one of: a service type, a UE type, a network slice, or a tenant associated with the network function.

In some implementations, the processing device determines that a priority level of the data packet meets or exceeds a threshold value to determine that the at least one parameter satisfies the notification criterion and proceeds to operation 330. In some implementations, the at least one parameter comprises a priority level of the data packet, the threshold criterion comprises a third threshold value indicating a high priority level, and to determine the at least one parameter satisfies the threshold criterion, the processing device determines that the priority level of the data packet is not smaller than the third threshold value.

At operation 330, responsive to determining that at least one parameter of the plurality of parameters associated with the data packet satisfies a threshold criterion, the processing device may send a notification to AMF. In some implementations, the processing device may send a notification to AMF to cause the AMF to send a paging message to IoT-UE and cause the buffered NF to send the stored data packet(s) to IoT-UE.

In some implementations, responsive to determining that no parameter of the plurality of parameters associated with the data packet satisfies a threshold criterion, the processing device may proceed back to operation 310 to allow the further data packet reception. In some implementations, the processing device may set a timer (e.g., the notification timer) to be started when storing a first data packet in the buffer, and responsive to sending the data packets stored in the buffer to the UE, reset the timer and restart the timer when storing the first data packet in the buffer.

Referring to FIGS. 4A and 4B, at operation 410, the processing device may perform an initialization process regarding the intelligent buffering. In some implementations, the initialization process may include configuring a set of parameters associated with the data packet, where the set of parameters associated with the data packet comprises at least one of: a size of the data packets stored in the buffer, a timer started when storing a first data packet in the buffer, or a priority level of the data packet. In some implementations, the initialization process may include configuring a set of a threshold criteria each corresponding to one parameter of the set of parameters (e.g., a first threshold value, a second threshold value, a third threshold value, a fifth threshold value) described above. In some implementations, the initialization process may include configuring a notification timer and the corresponding threshold criterion described above. In some implementations, the initialization process may include configuring a non-responding timer and the corresponding threshold criterion described above. In some implementations, the initialization process may include configuring the eDRX mechanism. In some implementations, the initialization process may include configuring the EPI mechanism. In some implementations, the initialization process may include configuring the EPI mechanism.

At operation 420, the processing device may receive a data packet and store the data packet in a buffer, which may be similar to or same as the operation 310. At operation 430A, the processing device may determine whether a size of data packets stored in the buffer satisfies a first threshold criterion, which may be similar to or same as a situation described with respect to the operation 320. At operation 430B, the processing device may determine whether a notification timer satisfies a second threshold criterion, which may be similar to or same as a situation described with respect to the operation 320. At operation 430C, the processing device may determine whether a priority level of the data packet satisfies a third threshold criterion, which may be similar to or same as a situation described with respect to the operation 320. Responsive to determining that no parameter of the plurality of parameters associated with the data packet satisfies a threshold criterion at operation 430A, 430B, or 430C, the processing device may proceed back to operation 420.

At operation 440, responsive to determining that at least one parameter of the plurality of parameters associated with the data packet satisfies a threshold criterion at operation 430A, 430B, or 430C, the processing device may send a notification to AMF, which may be similar to or same as the operation 330. At operation 450, the processing device may cause the AMF to send a paging message to IoT-UE. At operation 460, the processing device may determine whether the paging is successful (e.g., by determining whether a response to the paging message is received). At operation 470A, responsive to determining that the paging is successful (e.g., by determining that a response to the paging message is received), the processing device may cause the buffered NF to send the stored data packet(s) to IoT-UE. At operation 480A, the processing device may reset the notification timer such that the notification timer can be restarted when the empty buffer is used to store a new data packet.

At operation 470B, responsive to determining that the paging is not successful (e.g., by determining that a response to the paging message is not received), the processing device may determine whether an action criterion is satisfied by determining whether the non-responding timer meets or exceeds a threshold value (e.g., a fourth threshold value) or whether the size of the buffered data packet(s) meets or exceeds a threshold value (e.g., a fifth threshold value). At operation 480B, responsive to determining that the action criterion is satisfied (e.g., by determining that the non-responding timer meets or exceeds the fourth threshold value, or the size of the buffered data packet(s) meets or exceeds the fifth threshold value), the processing device may take the action towards the buffered data packet(s). In some implementations, the action towards the buffered data packet(s) may include flushing the buffer by deleting the data in the buffer, or sending a notification to the entity that generates the data packet(s) regarding the delivery failure of these data packets. In some implementations, the action towards the buffered data packet(s) may further include resetting the notification timer and the non-responding timer. Responsive to determining that the action criterion is not satisfied (e.g., by determining that the non-responding timer does not meet or exceed the fourth threshold value, or the size of the buffered data packet(s) does not meet or exceed the fifth threshold value), the processing device may proceed back to operation 420.

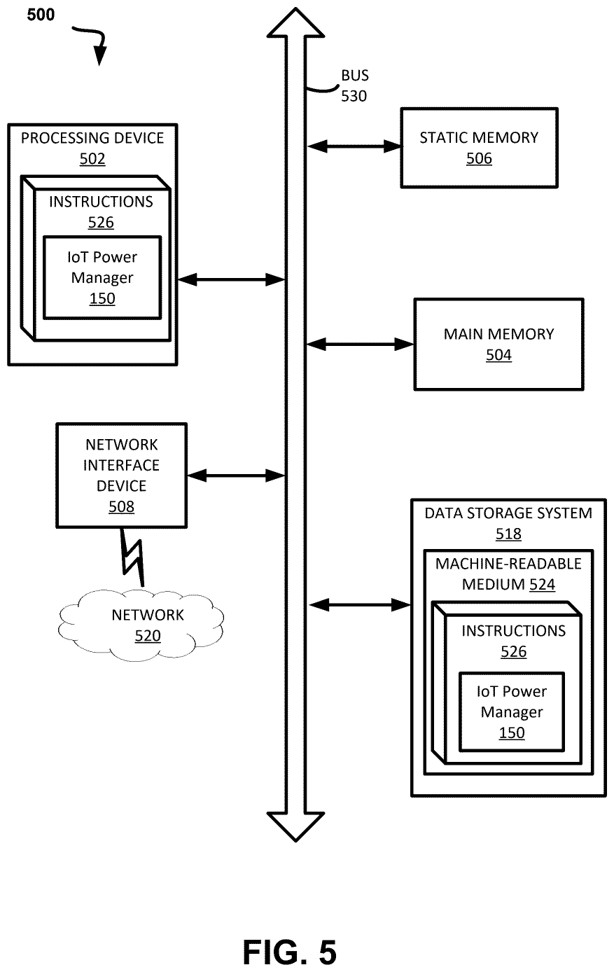

FIG. 5 illustrates an example machine of a computer system 500 within which a set of instructions, for causing the machine to perform any one or more of the methodologies discussed herein, can be executed. In some embodiments, the computer system 500 can be used to perform the operations of a controller (e.g., to execute an operating system to perform operations corresponding to the IoT power manager 150 of FIGS. 1-2). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520. The network 520 may correspond to the cellular network 120 of FIG. 1, or the 5G network 220 of FIG. 2.

The data storage system 518 can include a machine-readable storage medium 524 (also known as a computer-readable medium or a non-transitory computer-readable storage medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. In one embodiment, the processing device 502, the network interface 508, and the network 520 can correspond to the system 100 of FIG. 1, or the system 200 of FIG. 2.

In one embodiment, the instructions 526 include instructions to implement functionality corresponding to the IoT power manager 150 of FIGS. 1-2. While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method of intelligent buffering to reduce power consumption of a user equipment (UE) in a cellular network, the method comprising:
receiving, by a network function, a data packet directed to a user equipment (UE), wherein the UE comprises an internet of things (IoT) device;
storing the data packet in a buffer, wherein the buffer is specific to the network function;
determining whether at least one parameter of a plurality of parameters associated with the data packet satisfies a threshold criterion, wherein the plurality of parameters associated with the data packet are specific to the network function; and
responsive to determining that the at least one parameter satisfies the threshold criterion, sending, to an access and mobility management function (AMF), a notification to the UE, wherein the notification causes the AMF to send a paging message to the UE, and wherein the paging message indicates the UE to receive data packets stored in the buffer.

2. The method of claim 1, wherein the plurality of parameters associated with the data packet comprises at least one of: a size of the data packets stored in the buffer, a timer started when storing a first data packet in the buffer, or a priority level of the data packet.

3. The method of claim 1, wherein the at least one parameter comprises a size of the data packets stored in the buffer, wherein the threshold criterion comprises a first threshold value, and wherein determining that the at least one parameter satisfies the threshold criterion comprises determining that the size of the data packets stored in the buffer is not smaller than the first threshold value, wherein the first threshold value is predetermined based on at least one of: a service type, a UE type, a network slice, or a tenant associated with the network function.

4. The method of claim 1, wherein the at least one parameter comprises a timer started when storing a first data packet in the buffer, wherein the threshold criterion comprises a second threshold value, and wherein determining that the at least one parameter satisfies the threshold criterion comprises determining that the timer started when storing the first data packet the buffer is not smaller than the second threshold value, wherein the second threshold value is predetermined based on at least one of: a service type, a UE type, a network slice, or a tenant associated with the network function.

5. The method of claim 1, wherein the at least one parameter comprises a priority level of the data packet, wherein the threshold criterion comprises a third threshold value indicating a high priority level, and wherein determining that the at least one parameter satisfies the threshold criterion comprises determining that the priority level of the data packet is not smaller than the third threshold value.

6. The method of claim 1, wherein the network function comprises at least one of: user plane function (UPF), session management function (SMF), network exposure function (NEF), application function (AF).

7. The method of claim 1, further comprising:
setting a timer to be started when storing a first data packet in the buffer; and
responsive to sending the data packets stored in the buffer to the UE, resetting the timer and restarting the timer when storing the first data packet in the buffer.

8. A computing system to facilitate a cellular network, the computing system comprising:
one or more processing devices; and
memory communicatively coupled with and readable by the one or more processing devices and having stored therein processor-readable instructions which, when executed by the one or more processing devices, cause the one or more processing devices to perform operations comprising:
receiving, by a network function, a data packet directed to a user equipment (UE), wherein the UE comprises an internet of things (IoT) device;
storing the data packet in a buffer, wherein the buffer is specific to the network function;
determining whether at least one parameter of a plurality of parameters associated with the data packet satisfies a threshold criterion, wherein the plurality of parameters associated with the data packet are specific to the network function; and
responsive to determining that the at least one parameter satisfies the threshold criterion, sending, to an access and mobility management function (AMF), a notification to the UE, wherein the notification causes the AMF to send a paging message to the UE, and wherein the paging message indicates the UE to receive data packets stored in the buffer.

9. The computing system of claim 8, wherein the plurality of parameters associated with the data packet comprises at least one of: a size of the data packets stored in the buffer, a timer started when storing a first data packet in the buffer, or a priority level of the data packet.

10. The computing system of claim 8, wherein the at least one parameter comprises a size of the data packets stored in the buffer, wherein the threshold criterion comprises a first threshold value, and wherein determining that the at least one parameter satisfies the threshold criterion comprises determining that the size of the data packets stored in the buffer is not smaller than the first threshold value, wherein the first threshold value is predetermined based on at least one of: a service type, a UE type, a network slice, or a tenant associated with the network function.

11. The computing system of claim 8, wherein the at least one parameter comprises a timer started when storing a first data packet in the buffer, wherein the threshold criterion comprises a second threshold value, and wherein determining that the at least one parameter satisfies the threshold criterion comprises determining that the timer started when storing the first data packet the buffer is not smaller than the second threshold value, wherein the second threshold value is predetermined based on at least one of: a service type, a UE type, a network slice, or a tenant associated with the network function.

12. The computing system of claim 8, wherein the at least one parameter comprises a priority level of the data packet, wherein the threshold criterion comprises a third threshold value indicating a high priority level, and wherein determining that the at least one parameter satisfies the threshold criterion comprises determining that the priority level of the data packet is not smaller than the third threshold value.

13. The computing system of claim 8, wherein the network function comprises at least one of: user plane function (UPF), session management function (SMF), network exposure function (NEF), application function (AF).

14. The computing system of claim 8, wherein the operations further comprise:
setting a timer to be started when storing a first data packet in the buffer; and
responsive to sending the data packets stored in the buffer to the UE, resetting the timer and restarting the timer when storing the first data packet in the buffer.

15. One or more non-transitory, computer-readable storage media having computer-readable instructions thereon which, when executed by one or more processing devices of a cellular network, cause the one or more processing devices to perform operations comprising:
receiving, by a network function, a data packet directed to a user equipment (UE), wherein the UE comprises an internet of things (IoT) device;
storing the data packet in a buffer, wherein the buffer is specific to the network function;
determining whether at least one parameter of a plurality of parameters associated with the data packet satisfies a threshold criterion, wherein the plurality of parameters associated with the data packet are specific to the network function; and
responsive to determining that the at least one parameter satisfies the threshold criterion, sending, to an access and mobility management function (AMF), a notification to the UE, wherein the notification causes the AMF to send a paging message to the UE, and wherein the paging message indicates the UE to receive data packets stored in the buffer.

16. The one or more non-transitory, computer-readable storage media of claim 15, wherein the plurality of parameters associated with the data packet comprises at least one of: a size of the data packets stored in the buffer, a timer started when storing a first data packet in the buffer, or a priority level of the data packet.

17. The one or more non-transitory, computer-readable storage media of claim 15, wherein the at least one parameter comprises a size of the data packets stored in the buffer, wherein the threshold criterion comprises a first threshold value, and wherein determining that the at least one parameter satisfies the threshold criterion comprises determining that the size of the data packets stored in the buffer is not smaller than the first threshold value, wherein the first threshold value is predetermined based on at least one of: a service type, a UE type, a network slice, or a tenant associated with the network function.

18. The one or more non-transitory, computer-readable storage media of claim 15, wherein the at least one parameter comprises a timer started when storing a first data packet in the buffer, wherein the threshold criterion comprises a second threshold value, and wherein determining that the at least one parameter satisfies the threshold criterion comprises determining that the timer started when storing the first data packet the buffer is not smaller than the second threshold value, wherein the second threshold value is predetermined based on at least one of: a service type, a UE type, a network slice, or a tenant associated with the network function.

19. The one or more non-transitory, computer-readable storage media of claim 15, wherein the at least one parameter comprises a priority level of the data packet, wherein the threshold criterion comprises a third threshold value indicating a high priority level, and wherein determining that the at least one parameter satisfies the threshold criterion comprises determining that the priority level of the data packet is not smaller than the third threshold value.

20. The one or more non-transitory, computer-readable storage media of claim 15, wherein the network function comprises at least one of: user plane function (UPF), session management function (SMF), network exposure function (NEF), application function (AF).
